(19) United States
(12) Patent Application Publication
(10) Pub. No.: US 2011/0063636 A1
(43) Pub. Date: Mar. 17, 2011

(54) PRINTING APPARATUS

(75) Inventor: Kana SAKAMOTO, Nagoya-shi (JP)

(73) Assignee: BROTHER KOGYO KABUSHIKI KAISHA, Aichi-ken (JP)

(21) Appl. No.: 12/749,197

(22) Filed: Mar. 29, 2010

(30) Foreign Application Priority Data
Sep. 14, 2009 (JP) 2009-211725

(51) Int. Cl. G06F 15/00

(52) U.S. Cl. 358/1.9

(57) ABSTRACT

A printing apparatus comprising: a printing unit configured to perform a print processing based on a full-color mode and a non-full-color mode, the print processing being performed, in the full-color mode, based on coloring materials of a plurality of color and by using all the coloring materials required for printing of printing target data, the print processing being performed, in the non-full-color mode in which a part of the coloring materials required for printing of the printing target data is unavailable, by using the coloring materials except for the unavailable coloring material, a storage unit storing reprinting data including at least the image data of the color of the unavailable coloring material when the print processing is performed in the non full-color mode; and a reprinting unit performing a print processing by using the reprinting data after the coloring material which was unavailable in the non-full-color mode becomes available.

### CROSS REFERENCE TO RELATED APPLICATION

The present application claims priority from Japanese Patent Application No. 2009-211725, which was filed on Sep. 14, 2009, the disclosure of which is herein incorporated by reference in its entirety.

### TECHNICAL FIELD

The apparatuses and devices consistent with the present invention relate to a printing apparatus that is configured to perform a print processing based on coloring materials of a plurality of colors.

### BACKGROUND

There is a related art printing apparatus that performs a print processing based on a plurality of coloring materials without using one or more of the coloring materials required for the print processing of printing target data. For example, the related art printing apparatus discloses the technique of realizing K color using respective colors of CMY when the residual amount of K color has decreased, in a printing apparatus which forms a color image using the four colors of cyan (C), magenta (M), yellow (Y), and black (K).

### SUMMARY

However, the related art printing apparatus described above has the following disadvantages. That is, although it is possible to obtain a print without some coloring materials, the quality of the print in this case differs from a print using all of the coloring materials. For example, in the related art, a missing color (K) is substituted with respective other colors of CMY. However, the quality of the print obtained by CMY is often lower than a four-color print which had been originally planned. In order to obtain the print using coloring materials of all four colors that have been originally planned, it is necessary to send printing target data again after the coloring material of the missing color is refilled, and it is necessary for user to take time and effort.

The present invention was made in order to solve the above described advantages which are included in the related art printing apparatus. That is, the object of the present invention is to provide a printing apparatus capable of performing a print processing based on coloring materials of a plurality of colors and capable of simply acquiring a print which was originally planned after a coloring material which was unavailable becomes available.

According to an illustrative aspect of the present invention, there is provided a printing apparatus comprising: a printing unit that is configured to perform a print processing based on a full-color mode and a non-full-color mode, the print processing being performed, in the full-color mode, based on coloring materials of a plurality of color and by using all the coloring materials required for printing of printing target data, the print processing being performed, in the non-full-color mode in which a part of the coloring materials required for printing of the printing target data is unavailable, by using the coloring materials except for the unavailable coloring material, the printing unit configured to acquire image data corresponding to the color of each coloring material based on the printing target data to perform the print processing by using each image data; a storage unit that stores reprinting data including at least the image data of the color of the unavailable coloring material when the print processing is performed in the non full-color mode; and a reprinting unit that performs a print processing by using the reprinting data stored by the storage unit after the coloring material which was unavailable in the non-full-color mode becomes available.

The printing apparatus of the invention has a non-full-color mode which performs printing with the exception of an unavailable coloring material. As a case where the non-full-color mode is operated, for example, there are limitations on the use of a specific color depending on the lack of a coloring material, user settings, or the failure of a developing device. In the printing apparatus of the invention, when printing in the non-full-color mode is performed, reprinting data is stored. The reprinting data includes at least the image data of the color of an unavailable coloring material. Then, after the coloring material which was unavailable becomes available, printing is again performed using the stored reprinting data.

That is, in the printing apparatus of the invention, the image data of a color (missing color) which was unavailable is stored, and the image data of the missing color is printed after the coloring material of the missing color becomes available. For example, if all the image data including the image data of the missing color is stored, the full color image data is printed on a new sheet. Additionally, if only the image data of the missing color is stored, colors other than the missing color are printed on a sheet in the non-full color mode, and the image data of the missing color is printed so as to be superimposed on the printed sheet. Thereby, a print using all coloring materials is output. That is, a user does not spend the time and effort in sending printing target data again, and a print using all coloring materials is obtained.

### BRIEF DESCRIPTION OF THE DRAWINGS

Illustrative aspects of the invention will be described in detail with reference to the following figures wherein:

FIG. 1 is a perspective view showing a schematic configuration of a multi functional peripheral according to an embodiment;

FIG. 2 is a view showing a schematic configuration of an image forming unit of the multi functional peripheral shown in FIG. 1;

FIG. 3 is a view showing a schematic configuration of a process unit of a process unit of K color shown in FIG. 2;

FIG. 4 is a block diagram showing an electric configuration of the multi functional peripheral shown in FIG. 1;

FIG. 5 is a flow chart showing the procedure of the printing processing according to the first form;

FIG. 6 is a flow chart showing the procedure of reprinting processing according to the first form;

FIG. 7 is a view showing a display example of a reprinting selection screen; and

FIG. 8 is a flow chart showing the procedure of printing processing according to a second form.

### DETAILED DESCRIPTION OF EXEMPLARY EMBODIMENTS OF THE PRESENT INVENTION

An embodiment in which a printing apparatus according to the invention has been embodied will be described below in detail referring to the accompanying drawings. This form is obtained by applying the invention to a multi functional peripheral (MFP) which has a color printing function which performs printing using a plurality of color toners.

[Configuration of MFP]

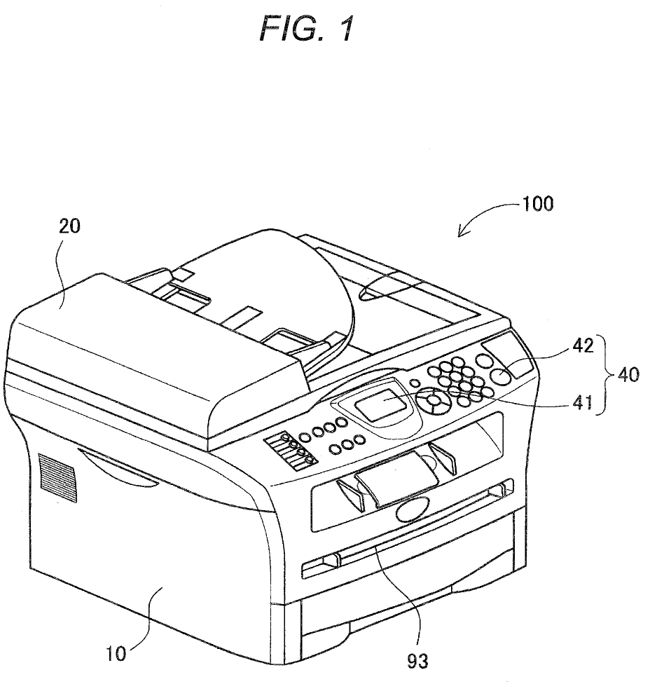

MFP 100 of this form, as shown in FIG. 1, includes an image forming unit 10 (one example of a printing unit) which performs printings an image on a sheet, and an image reading unit 20 which reads an image of a document. Additionally, a manual feed port 93 for a manual feeding tray is provided at the front face of the image forming unit 10. In the MFP 100, a sheet can be manually carried into an apparatus by inserting the sheet from the manual feed port 93 one by one.

Additionally, a display unit 41 including a liquid crystal display, and an operation panel 40 including a button group 42 constituted by various kinds of buttons (for example, respective buttons of a start key, a stop key, and ten keys) are provided at the front face of the image reading unit 20. The display of operating conditions and the input of operations by a user are made possible by the display unit 41 and the button group 42.

[Configuration of Image Forming Unit]

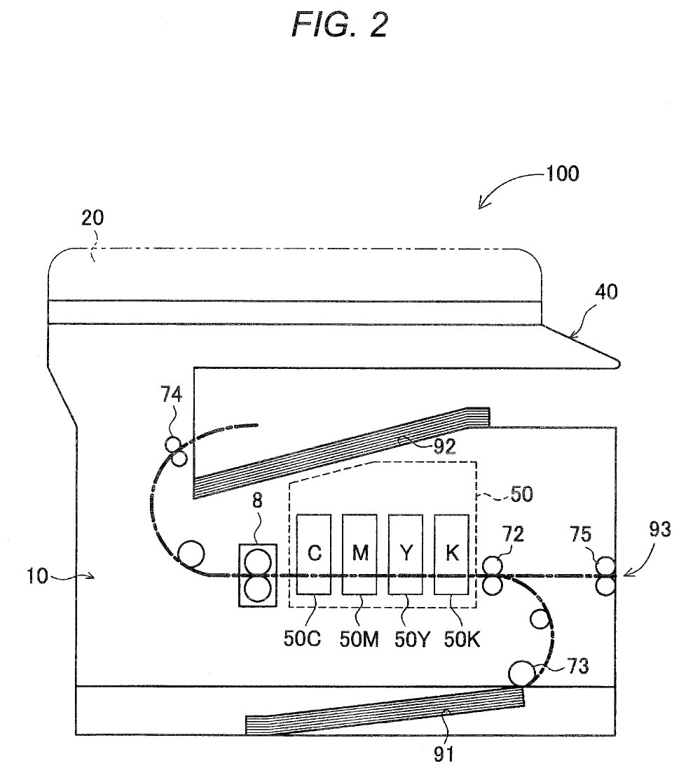

The image forming unit 10 of this form also forms an image by a well-known electro-photographic method and, as shown in FIG. 2, includes a process unit 50 which forms an image, a fixing device 8 which fixes a non-fixed toner, a sheet feed cassette 91 on which sheets before image formation are placed, and a sheet ejection tray 92 on which sheets after image formation are placed.

A substantially S-shaped conveying path is provided in the image forming unit 10 so that a sheet accommodated in the sheet feed cassette 91 positioned at the bottom of the image forming unit passes through a sheet feed roller 73, resist rollers 72, the process unit 50, and the fixing device 8, and is guided to the upper sheet ejection tray 92 via sheet ejection rollers 74. That is, the image forming unit 10 takes out a sheet placed on the sheet feed cassette 91 one by one, conveys the sheet to the process unit 50, and transfers a toner image formed in the process unit 50 to the sheet. Further, the sheet to which the toner image has been transferred is conveyed to the fixing device 8 where the toner image is heat-fixed on the sheet. Then, after fixation the sheet is ejected to the sheet ejection tray 92.

Additionally, a conveying path for manual sheet feed along which a sheet inserted from the manual feed port 93 passes through the sheet feed roller 75, the resist rollers 72, the process unit 50, and the fixing device 8, and is guided to the upper sheet ejection tray 92 via the sheet ejection rollers 74 is provided in the image forming unit 10.

The process unit 50 includes a process unit 50C which forms a C color image, a process unit 50M which forms an M color image, a process unit 50Y which forms a Y color image, and a process unit 50K which forms a K color image, and the respective process units 50C, 50M, 50Y, and 50K are arranged in opposition along the conveying path of sheets. The processing unit 50 superimposes toner images formed by the respective process units 50C, 50M, 50Y, and 50K on a sheet, thereby forming a color image. Meanwhile, when a monochrome image is formed, printing is made by forming a toner image by any one of the process units 50C, 50M, 50Y, and 50K.

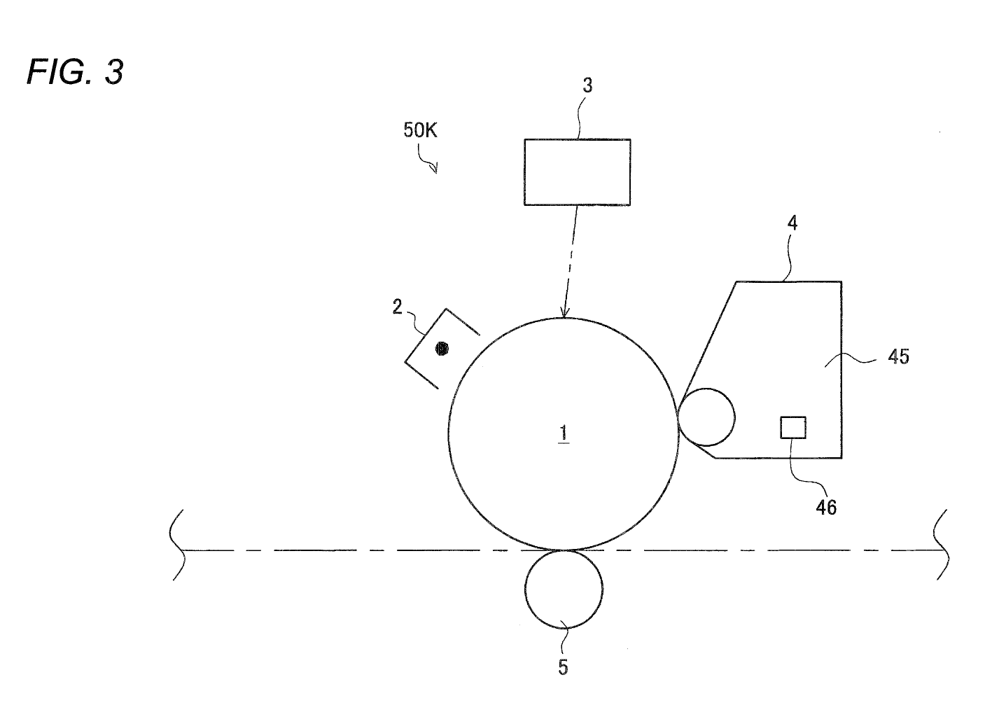

The process unit 50K, as shown in FIG. 3, has a photoconductor drum 1, a charger 2 which uniformly charges the surface of the photoconductor drum 1, an exposure device 3 which irradiates the surface of the photoconductor drum 1 with light to form an electrostatic latent image, a developing device 4 which performs development of the electrostatic latent image by a toner, and a transfer device 5 which transfer a toner image on the photoconductor drum 1 to a sheet. In addition, the other process units 50C, 50M, and 50Y also have the same configuration.

Additionally, the developing device 4 includes a toner tank 45 which stores a toner that is a coloring material, and a sensor 46 which detects that the residual amount of the toner in the toner tank 45 has become a predetermined amount or less. The MFP 100 is able to detect the empty state of the toner by an output signal of the sensor 46.

[Electric Configuration of MFP]

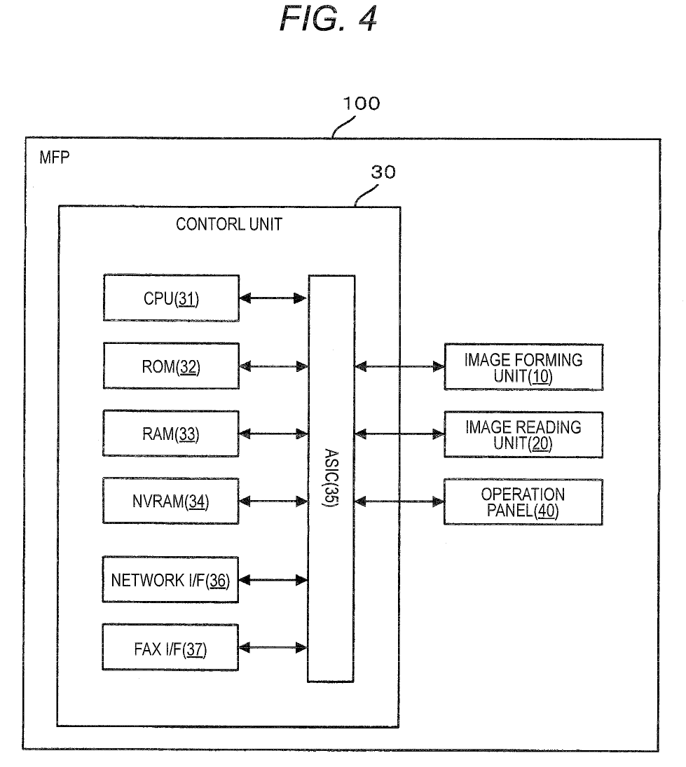

Subsequently, the electric configuration of the MFP 100 will be described. The MFP 100, as shown in FIG. 4, has a control unit 30 including a CPU 31, a ROM 32, a RAM 33, an NVRAM 34, an ASIC 35, and a network interface 36, and a FAX interface 37.

The CPU 31 executes the calculation for realizing various functions, such as an image reading function and an image forming function in the MFP 100, and becomes the center of control. Various control programs, various kinds of setting, initial values, etc. for controlling the MFP 100 are stored in the ROM 32. The RAM 33 is utilized as a working region to which various control programs are read out, or a storage region which stores image data temporarily. The NVRAM (Non-Volatile RAM) 34 is a storage means which has non-volatibility, and is utilized as a storage region where stores various kinds of setting, image data, etc.

The CPU 31 controls via the ASIC 35 respective components (for example, the ON timing of the exposure device which constitutes the image forming unit 10, driving motors (not shown) for various rollers which constitute the conveying path of sheets, motors (not shown) for the movement of image sensor units which constitutes the image reading unit 20) of the MFP 100, while making the processing results stored in the RAM 33 or NVRAM 34 according to signals sent from control programs read from the ROM 32 or from various sensors.

The network interface 36 is connected to networks, such as the Internet, thereby allowing the connection with an information processing apparatus, such as PC. The FAX interface 37 also is connected to a telephone line, thereby allowing the connection with a FAX apparatus of the other party. Also, data communication can be performed via the network interface 36 or the FAX interface 37.

[Printing Operation]

[First Form]

Subsequently, the printing operation of the MFP 100 will be described. The MFP 100 has a full-color mode which performs printing using all toners required for printing of printing target data, and a non-full-color mode which performs printing without using some of toners required for printing of printing target data.

As the full-color mode, for example, there are color printing which uses all CMYK toners, and monochrome printing which uses only one color from CMYK from the start. On the other hand, the non-full-color mode is a mode which performs printing without using certain colors, although the setting of the printing target data is color. In the MFP 100, the full-color mode and the non-full-color mode are properly used in printing processing if needed.

[Printing Processing]

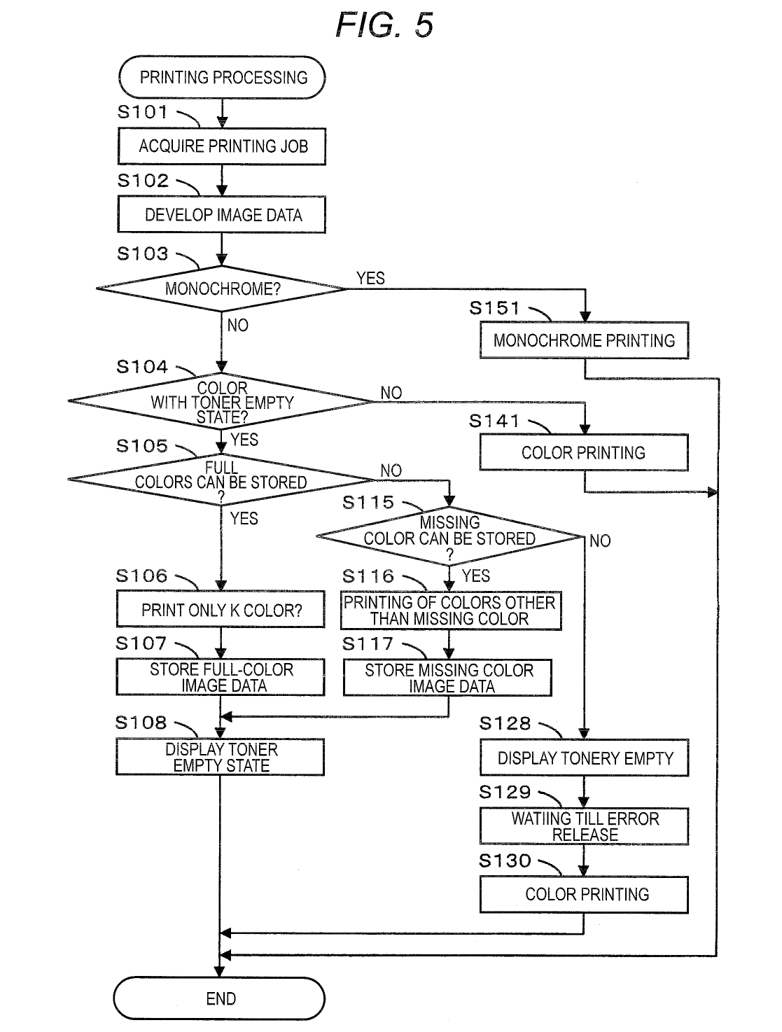

The procedure of the printing processing (an example of a printing unit and a storage unit) of the MFP 100 will be described referring to the flow chart of FIG. 5. This processing is executed as using the event where a printing instruction has been received (for example, printing job data is received or a copy instruction is input to the MFP 100 via the network interface 36 or the FAX interface 37) as a trigger.

First, printing job data is acquired (S101). Various kinds of printing settings other than printing target data accompany the printing job data. For example, setting of color or monochrome and setting of a toner save mode are included in this printing setting.

Next, development to the image data for every color is made on the basis of image data of the acquired printing job data (S102). The MFP 100 supports four colors of CMYK, and creates image data corresponding to respective colors of CMYK on the basis of image data. In addition, image data equivalent to four colors is developed in a temporary region of the RAM 33 of the MFP 100. Additionally, the image data developed in the temporary region is overwritten and erased by the next image data for printing at the next printing.

Next, it is determined whether or not the acquired printing job data is monochrome (S103). If the printing job data is monochrome (S103: YES), monochrome printing is performed using any one color (for example, K color) of CMYK (S151). In addition, the monochrome mode which performs printing using only one color from the start uses all toners required for printing, even if only one color is used. Therefore, the monochrome mode is the full-color mode.

On the other hand, if the printing job data is not monochrome (for example, color or auto-color) (S103: NO), it is determined whether or not there is any color the empty state of which has been detected (S104). If a toner empty state is not detected in full color (S104: NO), color printing is performed using the full colors of CMYK (S141).

If there is at least one color the empty state of which has been detected among CMYK (S104: YES), since color printing using toners of all four colors cannot be performed, printing in the non-full-color mode is tried. First, it is determined whether or not all image data equivalent to four colors can be stored (S105). In the MFP 100, memory regions are allocated in advance to predetermined regions other than the temporary region of the RAM 33 for storage of image data. It is determined whether or not the term “image data” can be stored by the comparison between the residual capacity of the memory regions (hereinafter referred to as a “memory for storage”) allocated for the storage of the image data, and the total size of image data equivalent to four colors.

If all image data equivalent to four colors can be stored (S105: YES), printing of only K color is performed (S106). Here, the printing is the non-full-color mode since printing is performed only with K color, irrespective of whether the color setting is made. In addition, if K color is the missing color, printing is performed only using colors other than K color that is the missing color. After printing of S106, all image data equivalent to four colors is stored in the memory for storage (S107).

On the other hand, if the image data equivalent to four colors cannot be stored (S105: NO), it is determined whether or not only the image data of the color which has become the missing color can be stored (S115). If the image data of the missing color can be stored (S115: YES), printing is performed using toners of full color with the exception of the missing color (S116). For example, if Y color is the missing color, printing is performed using toners of CMK colors. Even in this printing, since printing is performed with the exception of the missing color irrespective of whether the color setting is made, after printing in S116, only the image data of the missing color is stored in the memory for storage (S117).

After the storage of the image data by S107 or S117, the event where a toner empty state has occurred and printing has been made in the non-full-color mode is displayed on the display unit 41 of the operation panel 40 (S108), and this processing is ended.

On the other hand, if the image data of the missing color cannot be stored (S115: NO), the event where a toner empty state has occurred is displayed on the display unit 41 of the operation panel 40 (S128), and waiting is made by until an error is released (S129). In this form, an error is released by filling a toner of a missing color. If this error is released, printing of all image data equivalent to four colors is performed (S130). After the printing, this processing is ended without storing all of the image data equivalent to four colors in the memory for storage.

[Reprinting Processing]

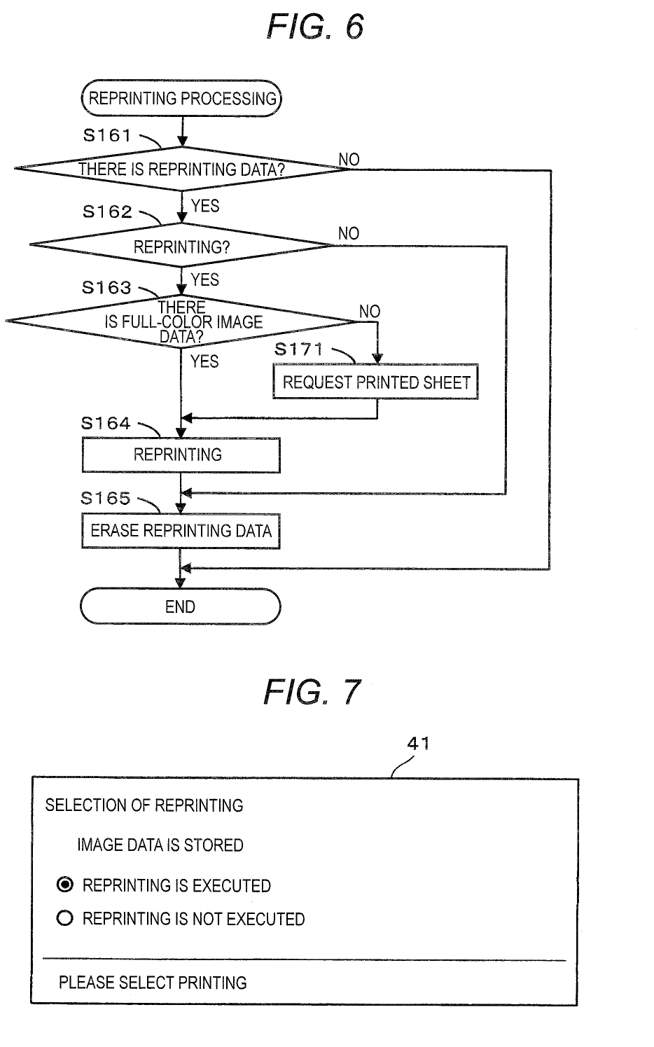

Subsequently, the procedure of the reprinting processing (an example of a reprinting unit and a receiving unit) of the MFP 100 will be described referring to the flow chart of FIG. 6. This processing is executed as using the event where a toner of a missing color which was unavailable becomes available (in this form, the event where a developing device the toner empty state of which has been detected is filled with a toner) as a trigger.

First, whether or not reprinting data is stored in the memory for storage of the MFP 100 (S161). In this form, the image data stored in S107 or S117 of the aforementioned printing processing becomes reprinting data. This processing is ended if the reprinting data is not stored (S161: NO).

On the other hand, if the reprinting data is stored (S161: YES), a user is made to select whether or not the printing using image data which has not been printed is performed (S162). As a means which makes a user perform the selection, for example, a selection screen as shown in FIG. 7 is displayed on the display unit 41 of the operation panel 40, and urges a user to select whether or not printing of the reprinting data is performed. If it is selected that printing of the reprinting data is not performed (S162: NO), the reprinting data is erased from the memory for storage (S165), and this processing is ended.

On the other hand, if it is selected that printing of the reprinting data is performed (S162: YES), it is determined whether or not the stored reprinting data is image data equivalent to full color (S163). That is, it is determined whether or not the reprinting data is image data equivalent to four colors or image data equivalent to only a missing color.

If the reprinting data is the image data equivalent to four colors (S163: YES), all the image data equivalent to four colors is printed (S164). Thereby, a print using toners of four colors is output. After the printing of the reprinting data, the reprinting data is erased from the memory for storage (S165), and this processing is ended.

If the reprinting data is the image data equivalent to only a missing color (S163: NO), a message requesting that a printed sheet printed in S106 or S116 of the aforementioned printing processing is set in a predetermined sheet feed unit is displayed on the display unit 41 of the operation panel 40 (S171). For example, it is displayed that a printed sheet is inserted from the manual feed port 93. Or, it is displayed that a start button is depressed after setting a printed sheet in the sheet feed cassette 91. After the setting of the printed sheet has been detected, image data of a missing color is printed on the printed sheet (S164). That is, the reprinting data is overwritten and printed on the printed sheet. Thereby, the missing color of the printed sheet is replenished, and as a result, a print using toners of four colors is output. After the printing of the reprinting data, the reprinting data is erased from the memory for storage (S165), and this processing is ended.

As described above, even if the MFP 100 is not able to output a print using toners equivalent to four colors by the printing processing, a print using toners equivalent to four colors can be output by the reprinting processing.

In addition, according to S130 of the printing processing, a print using toners of all four colors can be obtained even if the reprinting processing is not performed. However, the end of the printing processing is delayed until error release. That is, other printing processings (for example, even if one color is missing among toners of four colors, monochrome printing in other color is possible) are limited till the error release. Therefore, it is more preferable to end the printing processing first and allow the processing of the next printing job data, after image data of a missing color has been stored, as in the non-full-color mode of this form. With such a form, even if new printing is performed after the end of printing and the image data which has been in the temporary region is overwritten and erased, a print using toners equivalent to four colors can be output by the reprinting data stored in the memory for storage, without resending printing target data.

Additionally, although the MFP 100 also stores the reprinting data in the non-full-color mode, the reprinting data is not stored in the full-color mode. That is, the MFP 100 is not one in which image data is always left in the memory and performs reprinting using the image data. Therefore, a large burden is not applied to the memory.

[Second Form]

[Printing Processing]

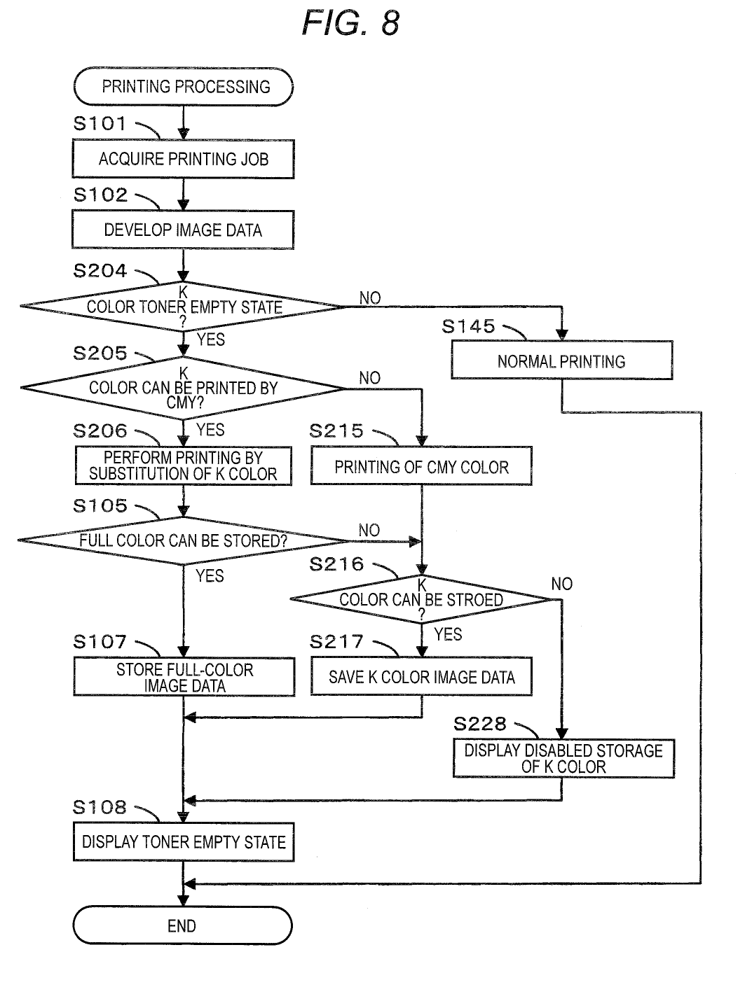

Subsequently, the procedure of the printing processing (an example of a printing unit and a storage unit) of a second form will be described referring to the flow chart of FIG. 8. This form is a specialized example in which the missing color is K color. In addition, the same processings as those of the first form are designated by the same reference numerals, and description thereof will be omitted.

Next, printing job data is acquired (S101), and image data of the acquired printing job data is developed to the image data for every color (S102).

Next, it is determined whether or not a toner empty state of K color is detected (S204). If a toner empty state of K color is not detected (S204: NO), normal printing is performed according to color setting (S145). In this form, if monochrome is set, monochrome printing is performed, and if monochrome is not set, color printing is performed.

If a toner empty state of K color is detected (S204: YES), it is determined whether or not K color can be substituted with CMY colors (S205). If the substitution of K color is possible (S205: YES), printing is performed by substituting K color with CMY colors (S206). In S206, if monochrome is set, printing of only K color which has been substituted is printed, and if monochrome is not set, printing of image data of each of CMY colors is also performed, in addition to K color which has been substituted.

Therefore, it is determined whether or not all image data equivalent to four colors can be stored (S105). In S206, although K color is substituted with CMY colors, a toner of K color is not used in practice. That is, this printing is printing in the non-full-color mode. Additionally, the print which is output may have a slight difference in tinge as compared to a print using a toner of K color. If all image data equivalent to four colors can be stored (S105: YES), all the image data equivalent to four colors are stored in the memory for storage so that reprinting can be performed using the toner of K color (S107).

On the other hand, if the image data equivalent to four colors cannot be stored (S105: NO), it is determined whether or not the image data of K color can be stored (S216). If the image data of K color can be stored (S216: YES), only the image data of K color is stored in the memory for storage (S217). If the image data of K color cannot be stored (S216: NO), a message showing that the image data of K color cannot be stored is displayed on the display unit 41 of the operation panel 40 (S228) for a certain period.

If the substitution of K color is not possible (S205: NO), printing only with CMY colors is performed (S215). Examples in which the substitution of K color is impossible correspond to, for example, a case where the substitution cannot be made depending on the specification and setting of the apparatus and setting, and a case where at least one color of CMY is the missing color in addition to K color.

After the storage of the image data by S107 or 5217, or after the display of the message in S228 for a certain period, the event where a toner empty state has occurred and printing has been made in the non-full-color mode is displayed on the display unit 41 of the operation panel 40 (S108), and this processing is ended.

In this form, by substituting K color with colors other than K color and performing printing, a print close to printing in the full-color mode can be obtained even in printing in the non-full-color mode. Hence, even in the non-full-color mode, the possibility that a user is satisfied with the print is high.

As described in detail above, when using a certain color toner color becomes impossible due to a toner empty state, the MFP 100 is operating in the non-full-color mode which performs printing except for a toner which is unavailable. When printing has been performed in the full-color mode, the image data for which printing is finished is not stored, and when printing has been performed in the non-full-color mode, the image data of at least a color (a missing color) which is unavailable is stored in the memory for storage. Then, after the toner which has become a missing color is filled, and has returned to “available”, printing of the stored image data, i.e., image data of the missing color is performed. This allows a print using all toners to be output. That is, a user does not spend the time and effort in sending printing target data again, and a print using all toners is obtained.

In addition, the present embodiment is merely illustrative and does not limit the invention at all. Accordingly, it is obvious that various improvements and alternations can be made without departing from the scope of the invention. For example, the invention can be applied to arbitrary apparatuses having a color printing function, such as a copying machine and a FAX apparatus, not limited to the multi functional peripheral (MFT). Additionally, the image formation method of the image forming unit may be an ink jet method, not limited to the electro-photographic method. That is, the coloring material may be a toner or may be ink.

Additionally, in the embodiment, the full-color mode and the non-full-color mode are switched depending on the detection of a toner empty state. However, the full-color mode and the non-full-color mode may be switched by printing settings of the subsequent printing job. For example, each developing device has a function of detecting a “toner low” (insufficient toner) state as the step before a toner empty state (toner depletion), and when the toner low is detected, printing settings of the subsequent printing job is determined. Also, if the subsequent printing job is designated color printing, printing in the non-full-color mode is performed, and if the subsequent printing job is not designated color printing, printing in the full-color mode is made to perform. That is, if the subsequent printing job is set to required color printing, printing of the current printing job is performed in the non-full-color mode in order to give priority to color printing of the subsequent printing job. This allows a suitable mode selection tailored to printing settings of the subsequent printing job.

Additionally, although the “unavailable” state of a toner is determined by the detection of a toner empty state in the embodiment, the invention is not limited thereto. For example, user settings (for example, designation in the toner save mode) of the “unavailable” state for every toner or developing device are possible, and the “unavailable” state of a toner may be determined according to this setting. The “unavailable” state of a toner may be determined depending on malfunctions, such as the failure of a developing device.

Additionally, in the embodiment, whether or not printing of the non-full-color mode is performed is switched depending on whether or not image data can be stored in the memory for storage (for example, S115 of FIG. 5). However, the execution conditions of the non-full-color mode are not limited thereto. The non-full-color mode may be executed, for example, by comparing the data size of image data with a predetermined threshold.

Additionally, the storage destination of image data is not limited to the predetermined region of the RAM 33, and may be, for example, the NVRAM 34. Additionally, as the aspect of the storage, besides the aspect in which image data to be stored is written in a memory, for example, an aspect may be adopted in which all image data is written in regions other the temporary region of the memory each time, and protection is made so that the image data to be stored is not overwritten or erased at that time.

According to a first aspect of the present invention, there is provided a printing apparatus comprising: a printing unit that is configured to perform a print processing based on a full-color mode and a non-full-color mode, the print processing being performed, in the full-color mode, based on coloring materials of a plurality of color and by using all the coloring materials required for printing of printing target data, the print processing being performed, in the non-full-color mode in which a part of the coloring materials required for printing of the printing target data is unavailable, by using the coloring materials except for the unavailable coloring material, the printing unit configured to acquire image data corresponding to the color of each coloring material based on the printing target data to perform the print processing by using each image data; a storage unit that stores reprinting data including at least the image data of the color of the unavailable coloring material when the print processing is performed in the non full-color mode; and a reprinting unit that performs a print processing by using the reprinting data stored by the storage unit after the coloring material which was unavailable in the non-full-color mode becomes available.

Further, according to a second aspect of the invention, in addition to the first aspect, the storage unit deletes the reprinting data therein after the reprinting unit performs the print processing by using the reprinting data. That is, after the storage object is achieved, it is preferable to cancel the storage of the reprinting data, and to relieve the load on a memory.

Further, according to a third aspect of the present invention, in addition to the first aspect or the second aspect, the reprinting data does not include the image data of the color which was available in the print processing of the non-full color mode. The load on the memory is relieved as printed image data is not stored.

Further, according to a fourth aspect of the present invention, in addition to any one of the first aspect to the third aspect, the storage unit is configured to select a first storage mode or a second storage mode based on a free space of the storage unit which stores the reprinting data, the full color image data being stored in the storage unit in the first storage mode, the image data of the color which was unavailable being stored in the storage unit in the second storage mode without storing the image data of the color which was available in the print processing of the non-full-color mode. If the printed image data is not stored, the load on the memory is relieved. However, in order to obtain a print using all coloring materials, it is necessary to perform printing on the sheet printed (printed sheet) in the non-full-color mode so as to be superimposed thereon. Thus, when the free space of a storage unit (memory) is sufficient to store the full color image data, the full color image data is stored so that, even if sheets other than the printed sheet are used, a print using all coloring materials is obtained. This improves convenience. The free space of the memory may be, for example, the physical residual capacity of a memory, and may be the residual capacity of a memory region allocated for the storage of the reprinting data.

Further, according to a fifth aspect of the present invention, in addition to anyone of the first aspect to the fourth aspect, when a residual amount of a coloring material becomes lower than a predetermined amount, the printing unit determines that the coloring material is unavailable, and executes the non-full-color mode. By executing reprinting immediately after a coloring material becomes available, a print using all coloring materials is obtained early.

Further, according to a sixth aspect of the present invention, in addition to anyone of the first aspect to fifth aspect, the reprinting unit performs the print processing by using the reprinting data when the coloring material which was unavailable becomes available. By this configuration, a user can be aware that all coloring materials have become available, and whether or not reprinting is performed can be determined depending on the user's instructions. In this way, the user's intention can be reflected through this.

Further, according to a seventh aspect of the present invention, in addition to anyone of the first aspect to the fifth aspect, K color can be expressed through other colors. For this reason, even in the printing in non-full-color mode, a print close to the printing in full-color mode can be obtained.

Further, according to an eighth aspect of the present invention, in addition to anyone of the first aspect to the seventh aspect, the unavailable coloring material in the non-full-color mode is a black color, and the printing unit prints the black color by using coloring materials other than the black color when the print processing is performed in the non-full color mode. That is, the storage of a large amount of reprinting data in the non-full-color mode applies a large load on memory. From this, the influence on other processing can be suppressed by avoiding the execution of the non-full-color mode depending on the amount of data.

Further, according to a ninth aspect of the present invention, in addition to anyone of the first aspect to the eighth aspect, the printing unit determines whether or not the print processing in the non-full-color mode is performed, based on an amount of the image data of the color that is the unavailable coloring material. According to the invention, a printing apparatus capable of performing printing using coloring materials of a plurality of colors and capable of simply acquiring an originally planned print after a coloring material which was unavailable becomes available is realized.

What is claimed is:

1. A printing apparatus comprising:
a printing unit that is configured to perform a print processing based on a full-color mode and a non-full-color mode, the print processing being performed, in the full-color mode, based on coloring materials of a plurality of color and by using all the coloring materials required for printing of printing target data, the print processing being performed, in the non-full-color mode in which a part of the coloring materials required for printing of the printing target data is unavailable, by using the coloring materials except for the unavailable coloring material, the printing unit configured to acquire image data corresponding to the color of each coloring material based on the printing target data to perform the print processing by using each image data;
a storage unit that stores reprinting data including at least the image data of the color of the unavailable coloring material when the print processing is performed in the non full-color mode; and
a reprinting unit that performs a print processing by using the reprinting data stored by the storage unit after the coloring material which was unavailable in the non-full-color mode becomes available.

2. The printing apparatus according to claim 1,
wherein
the storage unit deletes the reprinting data therein after the reprinting unit performs the print processing by using the reprinting data.

3. The printing apparatus according to claim 1,
wherein
the reprinting data does not include the image data of the color which was available in the print processing of the non-full color mode.

4. The printing apparatus according to claim 1,
wherein
the storage unit is configured to select a first storage mode or a second storage mode based on a free space of the storage unit which stores the reprinting data, the full color image data being stored in the storage unit in the first storage mode, the image data of the color which was unavailable being stored in the storage unit in the second storage mode without storing the image data of the color which was available in the print processing of the non-full-color mode.

5. The printing apparatus according to claim 1,
wherein
when a residual amount of a coloring material becomes lower than a predetermined amount, the printing unit determines that the coloring material is unavailable, and executes the non-full-color mode.

6. The printing apparatus according to claim 1,
wherein
the reprinting unit performs the print processing by using the reprinting data when the coloring material which was unavailable becomes available.

7. The printing apparatus according to claim 1, further comprising:
a receiving unit that reports that the printing unit can perform the print processing by using the reprinting data, and receives an instruction on whether or not reprinting is performed when the coloring material which was unavailable becomes available,
wherein
the reprinting unit performs the print processing by using the reprinting data in response to a reception of the instruction for performing reprinting by the receiving unit.

8. The printing apparatus according to claim 1,
wherein
the unavailable coloring material in the non-full-color mode is a black color, and the printing unit prints the black color by using coloring materials other than the black color when the print processing is performed in the non-full color mode.

9. The printing apparatus according to claim 1,
wherein
the printing unit determines whether or not the print processing in the non-full-color mode is performed, based on an amount of the image data of the color that is the unavailable coloring material.
